(19) United States
(12) Patent Application Publication
(10) Pub. No.: US 2015/0241857 A1
(43) Pub. Date: Aug. 27, 2015

(54) OPERATING UNIT OF A CONTROL DEVICE OF AN ADJUSTING DRIVE FOR FURNITURE

(71) Applicant: DEWERTOKIN GMBH, Kirchlengern (DE)

(72) Inventor: Armin Hille, Bielefeld (DE)

(73) Assignee: DEWERTOKIN GMBH, Kirchlengern (DE)

(21) Appl. No.: 14/381,852

(22) PCT Filed: Feb. 28, 2013
(86) PCT No.: PCT/EP2013/054093

§ 371 Date: Aug. 28, 2014

(30) Foreign Application Priority Data
Feb. 28, 2012 (DE) 10 2012 101 630.5

(51) Int. Cl. G05B 15/02

(52) U.S. Cl. CPC G05B 15/02

(57) ABSTRACT

The invention relates to a operating unit (10) for a control device (9) comprising at least one adjusting drive (7, 8) for a piece of furniture (1), said control device (9) being designed to control the at least one adjusting drive (7, 8) based on the control data captured by the operating unit (10). The operating unit (10) includes a detector (23) which detects a manual manipulation by a user, when a manual manipulation is detected, at least one illumination means (24) for illuminating operating elements (12-16) and/or display elements of the operating unit (10) is switched on. The invention also relates to a system comprising a control device and an operating unit in addition to a piece of furniture equipped therewith.

The invention relates to an operating unit of a control device of an adjusting drive for furniture, wherein the control device is set up to control the at least one adjusting drive on the basis of control data received by the operating unit. The invention further relates to a system comprising a control device and an operating device and a piece of furniture equipped therewith.

Adjusting drives, which are frequently also known as electromotive furniture drives, are installed in reclining and seat furniture in order to enable an adjustment of furniture parts such as seats, backrests, footrests etc in a convenient fashion relative to a base body of the piece of furniture and relative to each other. Adjustable seat furniture, especially so-called TV chairs or recliners, usually comprise a mechanically relatively complex furniture fitting which enables cooperation with a plurality of leavers and rod assemblies a complex sequence of movements of the various upholstered parts that are mounted thereon.

For triggering the adjusting drives and ensuring their power supply, a control device is arranged on or in the piece of furniture, which receives operating commands of a user via an operating unit and converts them into control signals for the adjusting drives.

The operating unit is usually arranged separate from the control device and is connected either in a cable-bound or wireless manner to the device. It is also possible to arrange the operating unit in an integrated manner in the control device. The specification DE 10 2008 033 627 A1 shows a control device for example for adjusting drives of a piece of furniture with a cable-bound operating unit and an additional operating unit which is coupled in a wireless fashion.

Especially when the piece of furniture equipped with the adjusting drives is a bed, actuation of the operating unit frequently occurs in the dark. Operating elements of the operating unit such as buttons or switches need to be sensed, wherein there is a likelihood of erroneous operation, Since a lighting device can frequently be activated by the control device via the operating unit, use of the operating unit in the dark is a matter that does occur frequently.

It is therefore the object of the present invention to provide an operating unit and a system consisting of a control device and operating unit which can also be operated in the dark in a purposeful and convenient manner.

This object is achieved by an operating unit and a system comprised of control device and operating unit with the features of the respective independent claim. Preferred further developments are the subject matter of the dependent claims.

An operating unit in accordance with the invention as described above is characterized in that it comprises at least one detector which detects manual handling by a user, wherein, upon detection of manual handling, at least one lighting means, especially a light-emitting diode, is activated for illuminating operating elements and/or display elements of the operating unit. The detector allows recognizing the intention to operate the unit by the user even before said user actuates a specific operating element. The illumination of the operating elements or display elements allows the user to find and actuate the desired operating element on the operating unit in a purposeful and secure way. Manual handling within the scope of the application shall be understood as being an action by the user which allows drawing a conclusion on an imminent actuation of the operating elements.

In a preferred embodiment of the operating unit, the detector is an acceleration sensor such as a vibration sensor, a position or inclination sensor, contact sensor, motion sensor, proximity sensor such as a capacitive proximity sensor, or a reflex light bar, or an acoustic sensor. These sensors advantageously allow recognizing manual handling of the operating unit without requiring the actuation of a pushbutton or a switch of the operating unit. In the case of contact or acceleration sensors or position or inclination sensors, a non-specific contact or movement of the operating unit is sufficient in order to enable the detection of the intention to perform an operating action. In the case of motion or proximity sensors and even in the case of acoustic sensors, the intention to perform an operating action can be detected before the operating unit is touched or picked up at all.

In a further advantageous embodiment of the operating unit, it is set up to output a signal for a control device after detecting manual handling of the operating unit. As a result, after the recognition of an intention to perform an operating action, the control device can also perform preparatory steps for the user operation. For example, the control device can activate an upstream mains cut-off unit in order to trigger adjusting drives during the following actuation of an operating element in a direct manner and without delay. Furthermore, the control device can activate a lighting device which is connected to the control device, e.g. floor lighting or a lamp arranged on bedside cabinets.

In a further advantageous embodiment of the operating unit, the operating elements are at least partly transparent, wherein the lighting means are arranged in such a way that they shine through the operating elements at least in part. The lighting means are also advantageously arranged in such a way that they shine through an at least partly transparent border of the operating elements. Both embodiments, which can also be used in a combined fashion, allow easy recognition and finding of the operating elements in the dark.

A system in accordance with the invention for controlling at least one adjusting drive of a piece of furniture comprises a control device connected to the adjusting device and a previously described operating unit. A piece of furniture in accordance with the invention comprises such a system. The advantages described in connection with the operating unit are achieved in this manner.

The invention will be explained below in closer detail by reference to the enclosed drawings, wherein:

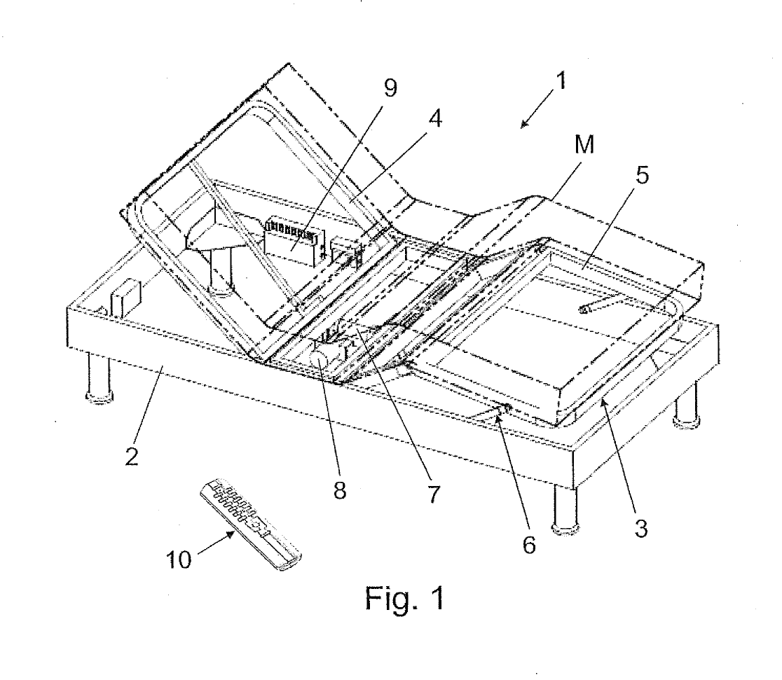

FIG. 1 shows a schematic perspective view of an exemplary furniture arrangement;

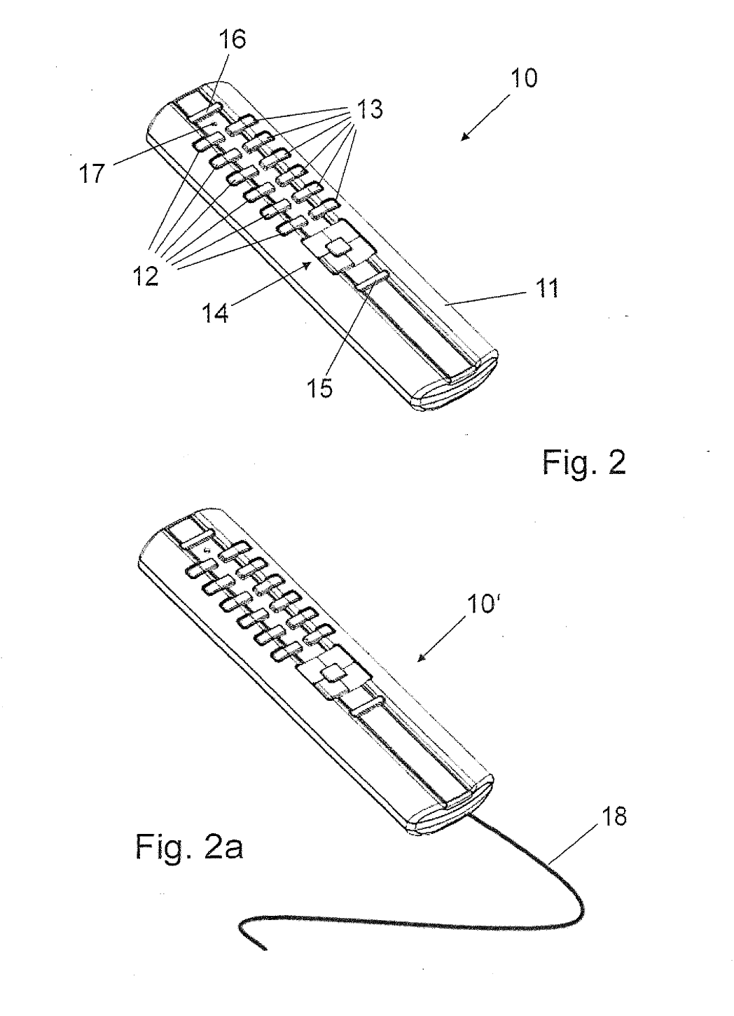

FIGS. 2 to 2a show schematic perspective views of an operating unit, and

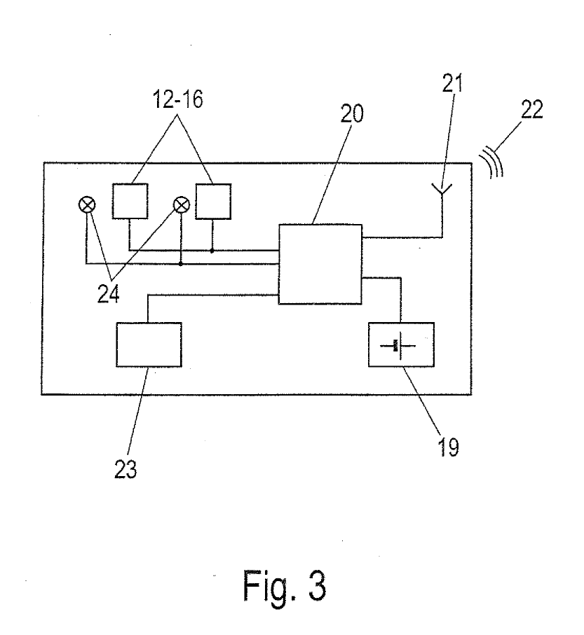

FIG. 3 shows a block diagram of an operating unit.

FIG. 1 shows an exemplary furniture assembly with a piece of furniture 1. FIGS. 2 and 2a show schematic perspective views of an operating unit 10, 10′.

A bed is shown in this case by way of example as a piece of furniture 1. The piece of furniture 1 comprises at least one support element 3 for accommodating items, upholstery, a mattress M and/or a person. The support element 3 is arranged as a slatted base, as a flat support surface or the like for example and is attached to a base element 2, which is a frame with feet in this case, for coupling the piece of furniture 1 to an installation location, e.g. a floor.

The support element 3 comprises a backrest part 4 and a leg part 5 in this case, which are arranged in a movably mounted manner relative to the support element 3 and/or a further support element or relative to the base element 2. This movable arrangement is realized in this case by means of a so-called motion fitting 6. The movement is arranged to be displaceable and/or pivotable.

The movably mounted backrest part 4 and the leg part 5 are respectively coupled to an adjusting drive 7, 8. As a result, the backrest part 4 is coupled to the electromotive adjusting drive 7. The electromotive adjusting drive 8 is provided for moving or adjusting the leg part 5.

The electromotive linear drives 7, 8 are arranged in this case as linear drives. The linear drives comprise one or several electric motors, wherein each motor is provided downstream with a speed reducing mechanism with at least one gear step. The speed reducing mechanism can be provided downstream with a further gear, e.g. in form of a threaded spindle mechanism, which produces from the rotary movement of the motor a linear movement of an output element. The last gear element or any further gear element connected thereto forms an output element. The output element of the respective electromotive adjusting drive is in connection with the respective furniture component (backrest part 4, leg part 5) or alternatively with a component connected to the base frame 2, so that the movable furniture components 4, 5 are adjusted relative to each other during operation of the electric motor of the respective adjusting drive 7, 8.

The electromotive adjusting drives 7, 8 are connected to a control device 9. Said connection can be arranged as a pluggable cable connection, which is not shown here in closer detail. The control device 9 comprises an electric supply unit, which provides electric power, e.g. from the grid, for the electromotive adjusting drives 7, 8. For this purpose, the control device 9 is connectable to a mains connection in this example via a mains cable to a mains plug. The mains plug supplies the mains voltage on the input side via the mains cable to the electric supply unit of the control device 9, which supplies a low voltage in form of a DC voltage on the secondary side and transmits this voltage to a motor control unit.

As an alternative, the control device 9 is provided upstream with a mains-dependent voltage supply with mains input (not shown in closer detail) and with a low voltage output on the secondary side, which supplies the low voltage in form of a DC voltage via a line.

The piece of furniture 1 is further associated with an operating unit 10, whose operating elements 12, 13 (see FIG. 2) control the electromechanical adjusting drives 7, 8 via the control device 9.

The operating unit 10 according to FIG. 2 is provided with a transmitter device or transmitter/receiver device for wireless transmission. The wireless transmission can be a radio transmission link, an optical transmission link (e.g. infrared) and/or an ultrasonic sound transmission link, wherein the control device 9 is provided with a respective receiver device.

In another embodiment, the operating unit 10 is arranged with a transmission line 18 in a wire-bound form, which is shown in FIG. 2a. The transmission line 18 can be connected to the control device 9, e.g. by a plug-in connection.

The operating unit 10 is provided with operating elements 12, 13, which are provided for operating a respective electromotive adjusting drive 7, 8. The operating elements 12, 13 are arranged as pushbuttons for example. For example, the operating elements 12 are used for moving the respectively movable furniture part in an upward direction and the operating elements 13 for lowering the respectively movable furniture part. FIGS. 2 and 2a show the operating units 10 for six adjusting drives.

When an operating element 12, 13 is actuated, a control signal is transmitted to the control device 9 for triggering the respective electromechanical adjusting drive 7, 8 via the transmission link in a wireless or wired-bound fashion.

An additional operating element 14, which can also consist of several operating elements and/or a combined operating element, is used for a so-called memory function of the electromotive adjusting drives 7, 8.

It can further be provided that further electrical components are connected to the control device 9, which are then also actuated via the operating unit 10 and can be controlled by the control device 9. Furthermore, additional functions such as a reading lamp and/or heating can be realized by means of further electrical components. The operating unit 10 comprises additional operating elements 15, 16 in order to operate the further electrical components, e.g. to switch them on or off, or to control them with respect to their power. The additional operating elements 14, 15, 16 can be arranged as pushbuttons and/or switches. In summary, the operating elements 12, 13 and the additional operating elements 14, 15, 16 are designated as operating elements 12 to 16.

The operating unit 10 is further provided with an indicator element 17, e.g. a light-emitting diode or a display unit. The indicator element 17 is used for example for displaying functionality, feedback, error display etc.

The control device comprises control switches which convert the control signals of the transmission link into switching signals for switching the respective adjusting drive 7, 8. The switching elements can be relay switches and/or semiconductor switches for example. The operating elements 12, 13 of the operating unit 10, which can be actuated manually, generate control signals which are converted in this case by the receiver of the control device 9 into control currents for the switching elements. In the case of the wire-bound operating unit 10 according to FIG. 2a, the operating elements 12, 13 switch the control current of the relay switches or semiconductor switches. In both cases, the power switches of the relay switches or the semiconductor switches switch the high motor current of the respective adjusting drive 7, 8.

FIG. 3 shows the operating unit 10 in a block diagram. A wireless operating unit as shown in FIG. 2 is shown here by way of example, which comprises a battery 19 for its power supply.

The operating unit 10 further comprises a control unit 20, which implements the functionality of the operating unit 10 by a microcontroller for example, in that it detects an actuation of the two operating elements 12 to 16 (shown here by way of example) and generates and transmits a respective signal to a control device, e.g. the control device 9 of FIG. 1. An antenna 21 and a transmission link 22 are shown by way of example for the transmission of the control signals. The operating unit 10 is therefore arranged in the example of FIG. 3 as a radio operating unit. It is understood that in addition to the illustrated two operating elements 12 the operating element 10 can comprise a plurality of operating elements 12, 13 and also additional operating elements 14 to 16, as described in connection with FIG. 2.

Furthermore, a display unit (not shown), e.g. a display, can be provided in this case. The display can also be touch-sensitive, i.e. it can be arranged as a so-called touchscreen, and thus additionally assume the functionality of the operating elements 12, 13 or the additional operating elements 14 to 16.

Lighting means 24 are provided in the operating unit 10, e.g. as background illumination of the operating elements 12 to 16. Light-emitting diodes are especially suitable as lighting means 24. The operating elements 12 to 16 are partly transparent for this purpose, by means of which an incorporated symbol can easily be recognized. It is alternatively possible to arrange the lighting means 21 in such a way that a border of the operating elements 12 is illuminated. If a flat display unit, e.g. a display, is provided, the background illumination of the display can also act as the lighting means 24.

Furthermore, a detector 23 is arranged in the operating unit 10, which emits an output signal that is also detected and processed by the control unit 20. If said output signal indicates manual handling of the operating unit 10, the lighting means 21 are activated by the control unit 20 for a predetermined and optionally adjustable time. If there is actually an actuation of one of the operating elements 12 to 16, it can be provided to reactivate the lighting means 24 again or to restart the predetermined time for which the lighting means 24 are activated.

It can optionally additionally be provided that the control unit 20 emits a signal indicating manual handling via the antenna 21 and the transmission link 22 in order to enable the control device 9 to respond to a presumably imminent actuation of an operating element 12 to 16. The control device 9 can activate a mains release device in order to switch a power supply unit for supplying the actuating drives from standby operation to active operation. It is further possible that that the control device 9 activates a lighting device that is controlled by the same.

In a further development of the illustrated operating unit 10, a brightness sensor can additionally be provided which detects the brightness in the ambient environment. The control unit 20 can be arranged in such a way that the lighting means 24 will only be activated when detecting manual handling by the detector 23 when the ambient brightness falls beneath a predetermined limit value.

The detector 23 can be a motion sensor for example which detects a movement of a user within a specific distance area around the operating unit 10 via infrared radiation emitted by the user. Such a motion sensor is advantageous because it can be operated with a very low quiescent current, which is an important criterion in wireless operating units 10 in order to prevent unnecessarily reducing the operational lifespan of batteries for the power supply of the operating unit 10.

Furthermore, an acceleration sensor can be used as a detector 23. In a known embodiment, which can be miniaturized in a cost-effective manner, such an acceleration sensor is arranged as an integrated micromechanical sensor and comprises a test mass whose gravitational force is determined, e.g. by a piezo sensor carrying the test mass. Any changes in the position or inclination of the detector 23, or any impacts or accelerations thereof, are reflected in its output signal, which is detected by the control unit 20. For detecting the change in the position, a sensor with an integrated ball can also be used which closes a contact when the position changes.

The mass of the ball in relation to gravity can actuate a switch. An electrically conductive ball or a solid body having a mass in general or a liquid having a mass and comprising an electrically conductive surface is preferable, wherein the solid body or the liquid is held in an enclosure. The enclosure comprises electrical contacts, wherein at least one electrical contact is closed during the change in the position of the body or the liquid, which is detected as a motion signal.

Furthermore, the control device 9 can also be integrated in the housing 11 of the operating unit 10. As a result, the initially described relay switches can be integrated completely or at least partly in the housing 11 of the operating unit 10. Semiconductor switches such as MOS-FETs (metal-oxide semiconductor field effect transistors) or IGBTs (insulating gate bipolar transistors) can be considered as an alternative to the relay switches.

Furthermore, a proximity sensor can be used as a detector 23 which detects the approach towards or contact with the operating unit on the basis of capacitive changes or in form of a reflection light barrier.

Finally, an acoustic sensor can be considered as a detector 23 which detects a noise occurring during the gripping of the operating unit 10 or during the removal of the operating unit 10 from a retainer, thus indicating the intention of the user to use the unit.

An embodiment is provided which especially protects the batteries when the lighting means 24 is connected to a time-delay switch in order to enable its deactivation in the case of unintended use. If the piece of furniture 1 or at least the operating unit 10 is transported over a longer distance, the lighting means 24 is operated permanently. If the operating unit 10 is placed on a piece of furniture 1 with activated massage function, the lighting means 24 could also be operated permanently. Both cases will lead to premature failure of the battery 19. A timer in form of an off-delay is thus associated in an inventive manner with the lighting means 24, which off-delay will interrupted the power supply to the lighting means 24 after a predetermined time interval after non-actuation of an operating button 12, 13, which even occurs when the detector 23 intends to operate the lighting means 24. The interruption of the power supply to the lighting is 24 is only terminated when a button 12 to 16 is actuated. The time interval is typically 30 seconds.

Furthermore, the lighting means 24 can be switched on and off. Gradual deactivation is preferable, wherein the light becomes gradually darker within a short period of time of up to 3 seconds and will then extinguish.

### LIST OF REFERENCE NUMERALS

1 Piece of furniture
2 Base element
3 Support element
4 Backrest part
5 Leg part
6 Motion fitting
7, 8 Adjusting drive
9 Control device
10 Operating unit
11 Housing
12, 13 Operating element
14 to 16 Additional operating element
17 Indicator element
18 Transmission line
19 Battery
20 Control unit
21 Antenna
22 Transmission link
23 Detector
24 Lighting means
M Mattress

What is claimed is:

1.-11. (canceled)

12. An operating unit for a control device of at least one adjusting drive for a piece of furniture, with the control device being configured to control the at least one adjusting drive in response to control data received by the operating unit, said operating unit comprising:
at least one detector configured to detect manual handling by a user;
operating elements and/or display elements; and
at least one lighting unit activated when manual handling is detected to illuminate the operating elements and/or display elements.

13. The operating unit of claim 12, wherein the detector is an acceleration sensor, a position or inclination sensor, a contact sensor, a motion sensor, a proximity sensor, or an acoustic sensor.

14. The operating unit of claim 13, wherein an integrated micromechanical sensor is used as an acceleration sensor or as a position or inclination sensor.

15. The operating unit of claim 13, wherein a ball sensor is used as a position or inclination sensor having a movable ball to close a contact.

16. The operating unit of claim 12, wherein the operating elements are at least partly transparent, said lighting unit being configured to shine through the operating elements at least in part.

17. The operating unit of claim 12, wherein the lighting unit is configured to shine through an at least partly transparent border of the operating elements.

18. The operating unit of claim 12, wherein the lighting unit includes light-emitting diodes.

19. The operating unit of claim 12, further comprising a timer configured to activate the lighting unit for a predetermined time interval after the detection of manual handling by a user.

20. The operating unit of claim 12, wherein the detector is configured to transmit a signal to the control device when manual handling by a user is detected.

21. A system for controlling at least one adjusting drive of a piece of furniture, comprising:
an operating unit including at least one detector configured to detect manual handling by a user, operating elements and/or display elements, and at least one lighting unit activated when manual handling is detected to illuminate the operating elements and/or display elements; and
a control device connected to the at least one adjusting drive and configured to control the at least one adjusting drive in response to control data received by the operating unit.

22. The system of claim 21, wherein the detector is an acceleration sensor, a position or inclination sensor, a contact sensor, a motion sensor, a proximity sensor, or an acoustic sensor.

23. The system of claim 22, wherein an integrated micromechanical sensor is used as an acceleration sensor or as a position or inclination sensor.

24. The system of claim 22, wherein a ball sensor is used as a position or inclination sensor having a movable ball to close a contact.

25. The system of claim 21, wherein the operating elements are at least partly transparent, said lighting unit being configured to shine through the operating elements at least in part.

26. The system of claim 21, wherein the lighting unit is configured to shine through an at least partly transparent border of the operating elements.

27. The system of claim 21, wherein the lighting unit includes light-emitting diodes.

28. The system of claim 21, further comprising a timer configured to activate the lighting unit for a predetermined time interval after the detection of manual handling by a user.

29. The system of claim 21, wherein the detector is configured to transmit a signal to the control device when manual handling by a user is detected.

30. A piece of furniture, comprising:
a frame element;
a support element movably guided in the frame element via at least one adjusting drive; and
a system for controlling the at least one adjusting drive, said system comprising an operating unit including at least one detector configured to detect manual handling by a user, operating elements and/or display elements, and at least one lighting unit activated when manual handling is detected to illuminate the operating elements and/or display elements, and a control device connected to the at least one adjusting drive and configured to control the at least one adjusting drive in response to control data received by the operating unit.
